(19) United States
(12) Patent Application Publication
(10) Pub. No.: US 2019/0070944 A1
(43) Pub. Date: Mar. 7, 2019

(54) Generator and Electrical Motor for Multi-Axle Vehicles

(71) Applicant: Erik Soto, Miami, FL (US)

(72) Inventor: Erik Soto, Miami, FL (US)

(21) Appl. No.: 16/182,350

(22) Filed: Nov. 6, 2018

Related U.S. Application Data
(63) Continuation-in-part of application No. 15/380,252, filed on Dec. 15, 2016, now Pat. No. 10,150,358.
(60) Provisional application No. 62/268,633, filed on Dec. 17, 2015.

(51) Int. Cl. B60K 1/00; B60K 1/04; H02K 7/00; H02K 11/00

(52) U.S. Cl. CPC B60K 1/00; B60K 1/04; B60K 6/52; H02K 11/0094; B60K 2001/001; H02K 7/006

(57) ABSTRACT

A generator and electrical motor includes a main axle assembly housing; a wheel axle that extends through the main axle assembly housing; a wheel statically coupled to each end of the wheel axle; a plurality of magnets coupled to a circumference of the wheel axle; a stator within the main axle assembly housing, the stator including a field winding that surrounds the wheel axle, such that rotation of the wheel axle induces a current in the field winding; and at least one vehicle mount on an exterior of the main axle assembly, the at least one vehicle mount configured for coupling to the vehicle.

### CROSS-REFERENCE TO RELATED APPLICATIONS

This patent application is a continuation in part of patent application Ser. No. 15/380,252 filed Dec. 16, 2016 and entitled “Generator and Electrical Motor for Multi-Axle Vehicles”, which claims priority to provisional patent application No. 62/268,633 filed on Dec. 17, 2015 and entitled “Tractor Trailer with a Motor and Generator”.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates generally to a multi-axle gas electric hybrid vehicle, more particularly to a vehicle with an internal combustion engine and a plurality of axle mounted generators which power an electric motor. A user of the present invention is able to reduce the amount of fuel consumed by a multi-axle vehicle by employing the use of multiple generators to power an electric motor, thereby augmenting the drive power output of the vehicle's powertrain.

### BACKGROUND

The use of traditional internal combustion (IC) engine results in pollution and the destruction of the environment. Additionally, while using an internal combustion engine much of the generated energy is lost as heat. Another drawback, to the continued use of ICE vehicles, is that they rely on oil reserves, which are known to be a diminishing resource. However, because of the amount of time and energy spent developing IC engine vehicles, there is a considerable amount of existing infrastructure. This infrastructure gives a vehicle owner the assurance that there will be locations to refuel or repair the vehicle in virtually any country on the planet.

A new trend in automotive technology is the use of electric vehicles (EV). Because these vehicles do not consume fuel, EVs reduce the operating cost for a user. In addition to lowered operating costs, EVs do not produce carbon emissions, and therefore help to reduce the rate of environmental pollution. Despite these benefits, the infrastructure for refueling and repairing EVs does not have significant global penetration. Therefore, when choosing between IC engine vehicles and EVs, a user is often presented with the tradeoff of reliability versus environmental conscientiousness.

The present invention, the generator and electrical motor for multi-axle vehicles, addresses these issues by marrying the benefits of an EV to the reliability of an IC generator. The present invention uses an IC generator to produce the electrical power required to operate the electric motor. By coupling a plurality of generators to the axles of a vehicle, the present invention produces enough energy to charge a battery bank and power an electric motor. Using an onboard computer, the present invention is able to determine when sufficient power is being produced. The present invention then switches off the IC generator and relies on electric power alone. The power stored in the battery bank is used to power the electric motor and any other vehicle systems, such as lights, air conditioners, radios, and the like. Because the present invention employs a plurality of axle-coupled generators, the system can be adapted for use with any multi-axle vehicle, such as trains, cars, tanks, trucks, and the like.

### BRIEF SUMMARY

A generator and electrical motor is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, generator and electrical motor includes a main axle assembly housing; a wheel axle that extends through the main axle assembly housing; a wheel statically coupled to each end of the wheel axle; a plurality of magnets coupled to a circumference of the wheel axle; a stator within the main axle assembly housing, the stator including a field winding that surrounds the wheel axle, such that rotation of the wheel axle induces a current in the field winding; and at least one vehicle mount on an exterior of the main axle assembly, the at least one vehicle mount configured for coupling to the vehicle.

In another embodiment, system for providing generation of electrical energy in a multi-axle vehicle, comprising: a) a generator and electrical motor comprising: a main axle assembly housing; a wheel axle that extends through the main axle assembly housing; a wheel statically coupled to each end of the wheel axle; a plurality of magnets coupled to a circumference of the wheel axle; a stator within the main axle assembly housing, the stator including a field winding that surrounds the wheel axle, such that rotation of the wheel axle induces a current in the field winding; and at least one vehicle mount on an exterior of the main axle assembly, the at least one vehicle mount configured for coupling to the vehicle; b) a battery bank conductively coupled with the main axle assembly such that electrical current produced by the main axle assembly charges batteries in the battery bank; and c) at least one drive axle for the multi-axle vehicle, the at least one drive axle being operatively coupled to the generator and electrical motor, wherein the generator and electrical motor is used to rotate the at least one drive axle.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the disclosed embodiments. The embodiments illustrated herein are presently preferred, it being understood, however, that the claimed embodiments are not limited to the precise arrangements and instrumentalities shown, wherein:

FIG. 1 is a block diagram illustrating the connections between the components of the present invention.

FIG. 2 is a flowchart illustrating the workflow of the power management unit in the present invention.

FIG. 3 is a block diagram illustrating the arrangement of components used in one embodiment of the present invention that is integrated into a semi-trailer truck.

FIG. 4 is a right-side view of a semi-trailer truck equipped with one embodiment of the present invention.

FIG. 5 is a cross sectional view of an axle and electrical generator, according to one embodiment of the present invention.

FIG. 6 is a close-up, cross sectional view of the axle and electrical generator of FIG. 5, according to one embodiment of the present invention.

The following detailed description incorporates a description of the drawings defined above.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The present invention, the generator and electrical motor for multi-axle vehicles, addresses these issues by marrying the benefits of an EV to the reliability of an IC generator. The present invention uses an IC generator to produce the electrical power required to operate the electric motor. By coupling a plurality of generators to the axles of a vehicle, the present invention produces enough energy to charge a battery bank and power an electric motor. Using an onboard computer, the present invention is able to determine when sufficient power is being produced. The present invention then switches off the IC generator and relies on electric power alone. The power stored in the battery bank is used to power the electric motor and any other vehicle systems, such as lights, air conditioners, radios, and the like. Because the present invention employs a plurality of axle-coupled generators, the system can be adapted for use with any multi-axle vehicle, such as trains, cars, tanks, trucks, and the like.

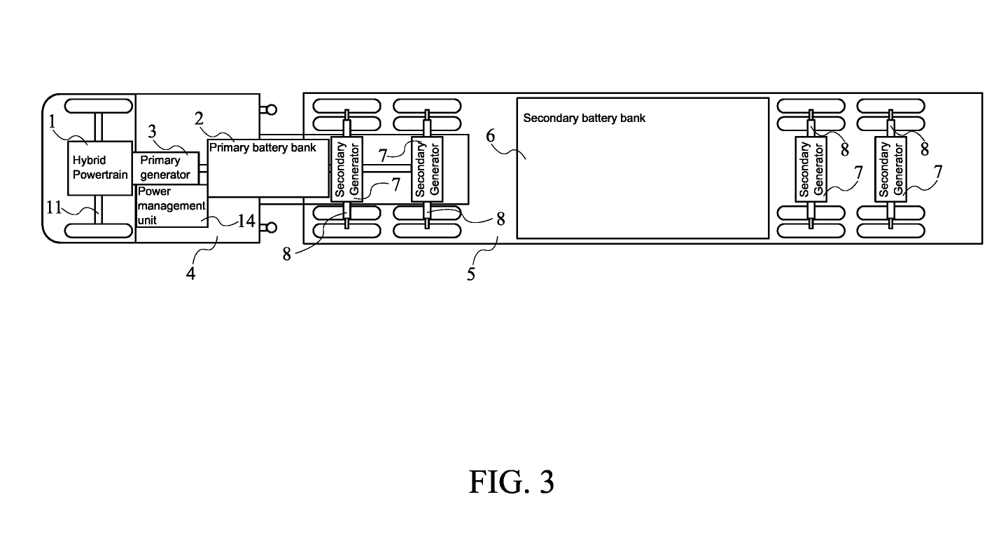

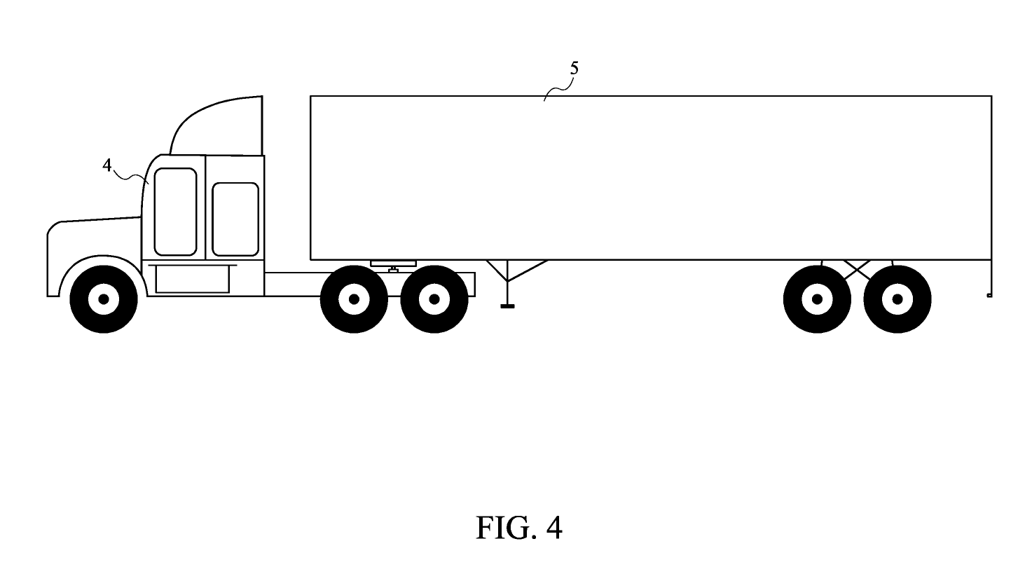

As can be seen in FIG. 3 and FIG. 4, the present invention, the generator and electrical motor for multi-axle vehicles, is a system that makes use of electric motors to provide the drive force required to propel a vehicle with two or more axles. The present invention employs at least one primary generator 3 to provide the initial electrical power required for the electric motors to propel the vehicle. Additionally, an aim of the present invention is to employ at least one secondary generators 7 to convert a portion of the kinetic energy generated by the movement of the vehicle into electrical energy. In this way, the present invention improves upon traditional vehicles.

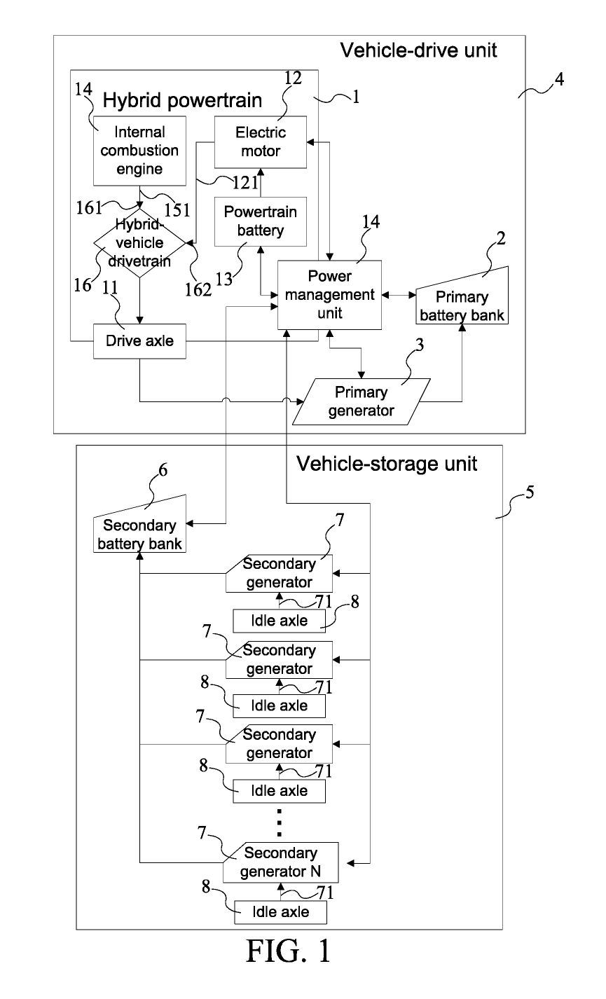

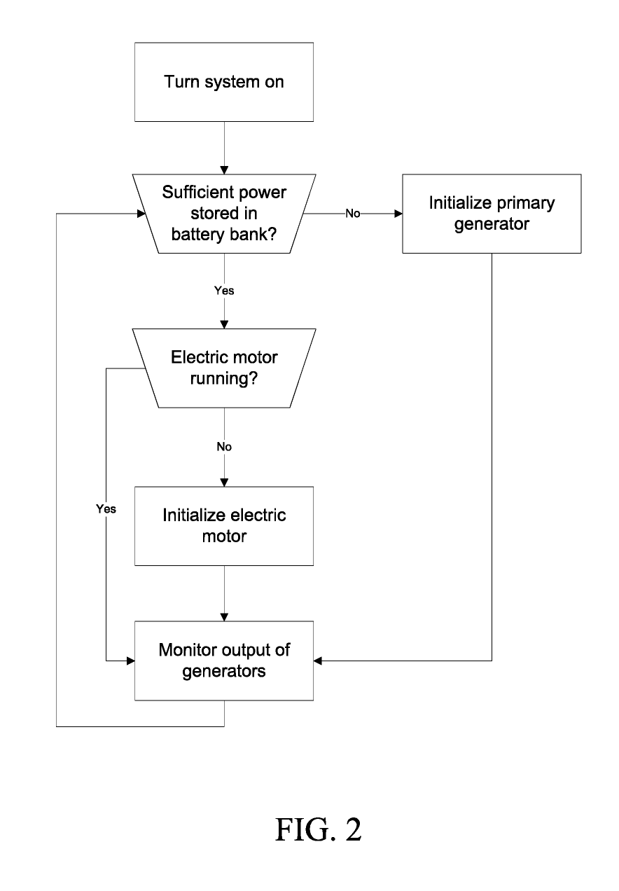

As can be seen in FIG. 1, FIG. 2, and FIG. 3, the present invention comprises a hybrid powertrain 1, a primary battery bank 2, and a primary generator 3. The hybrid powertrain 1 provides the drive power for the present invention by converting electrical energy into mechanical energy. The hybrid powertrain 1 comprises at least one drive axle 11, at least one electric motor 12, a powertrain battery 13, and a power management unit 14. The at least one drive axle 11 is an axle that is used as the axis about which the wheels of a vehicle rotate. The at least one electric motor 12 is operatively coupled to the at least one drive axle 11, wherein the at least one electric motor 12 is used to rotate the at least one drive axle 11. As a result, the at least one electric motor 12 provides the drive force to the at least one drive axle 11. This drive force is then transferred to the vehicle's wheels by the at least one drive axle 11. The powertrain battery 13 is a rechargeable battery used to provide electrical power to the at least one electric motor 12. Similarly, the primary battery bank 2 is a bank of rechargeable batteries used to store and supply electrical power for the present invention. The powertrain battery 13 functions as a local power source for the hybrid powertrain 1 that enables the at least one electric motor 12 to continue functioning if the primary battery bank 2 becomes disconnected. The primary battery bank 2 and the powertrain battery 13 are electrically connected to the at least one electric motor 12 so that the primary battery bank 2 and the powertrain battery 13 are able to provide the electrical power required to operate the at least one electric motor 12. The primary generator 3 is electrically connected to the primary battery bank 2 and the powertrain battery 13. Consequently, the primary generator 3 is able to charge the primary battery bank 2 and the powertrain battery 13. The power management unit 14 is a power conditioning system that acts as a voltage and current regulator for the electrical components of the present invention. The primary battery bank 2, the powertrain battery 13, the at least one electric motor 12, and the primary generator 3 are electrically connected to the power management unit 14. Thus, the power management unit 14 is used to distribute regulated electrical power from the primary generator 3 to the primary battery bank 2, the powertrain battery 13, and the at least one electric motor 12. Additionally, the primary generator 3 is preferably a compressed natural gas generator.

As can be seen in FIG. 1 and FIG. 3, in a first embodiment of the present invention, the hybrid powertrain 1 further comprises an internal combustion (IC) engine 15 and a hybrid-vehicle drivetrain 16. The hybrid-vehicle drivetrain 16 is a drivetrain system that delivers the drive power supplied by two or more power sources to the drive axle 11. In the first embodiment of the present invention, the IC engine 15 and the at least one electric motor 12 function as the power supplies for the hybrid-vehicle drivetrain 16. As such, an output 151 of the IC engine 15 is torsionally coupled to a first input 161 of the hybrid-vehicle drivetrain 16. Accordingly, the IC engine 15 supplies drive power to the hybrid-vehicle drivetrain 16. Similarly, an output 121 of the at least one electric motor 12 is torsionally coupled to a second input 162 of the hybrid-vehicle drivetrain 16 so that the at least one electric motor 12 is able to function as a second supply of drive power for the hybrid-vehicle drivetrain 16. In this first embodiment, the hybrid-vehicle drivetrain 16 is used to select if one or more of the power supplies will be used to provide drive power to the drive axle 11. Because of this, the hybrid-vehicle drivetrain 16 is able to select the most efficient source of drive power based on environmental conditions. In a second embodiment of the present invention, an input 31 of the primary generator 3 is torsionally connected to the at least one drive axle 11. Consequently, the primary generator 3 is able to convert a portion of the kinetic energy of the drive axle 11 into electrical energy.

As can be seen in FIG. 1 and FIG. 3, the present invention further comprises a vehicle-drive unit 4. The vehicle-drive unit 4 is the portion of a vehicle used to house users as well as the components required to supply the drive power needed to propel the vehicle. As such, the hybrid powertrain 1, the primary battery bank 2, and the primary generator 3 are mounted onto the vehicle-drive unit 4. As a result, the vehicle-drive unit 4 is able to function as the tractor of a semi-trailer truck, or the locomotive of a train.

As can be seen in FIG. 1 and FIG. 3, the present invention further comprises at least one vehicle-storage unit 5 and a secondary battery bank 6. The at least one vehicle-storage unit 5 is an ancillary portion of a vehicle that is detachably connected to the vehicle-drive unit 4 and is used to store cargo. For example, the at least one vehicle-storage unit 5 is able to function as the trailer of a semi-trailer truck or one or more of the cars on a train. The secondary battery bank 6 is a supplementary battery bank that is used to augment the function of the primary battery bank 2. The secondary battery bank 6 is electrically connected to the power management unit 14. Consequently, electrical energy stored within the secondary battery bank 6 can be delivered to the hybrid powertrain 1 through the power management unit 14. Additionally, the secondary battery bank 6 is positioned within the at least one vehicle-storage unit 5. Thus, the secondary battery becomes a piece of cargo that is transported by the at least one vehicle-storage unit 5.

As can be seen in FIG. 1 and FIG. 3, the present invention further comprises at least one secondary generator 7, at least one vehicle-storage unit 5, and at least one idle axle 8. The at least one secondary generator 7 is an electrical generator used to transform kinetic energy into electrical energy. The at least one idle axle 8 is an axle of a vehicle that supports the vehicle, yet does not provide any drive power to propel the vehicle. The at least one idle axle 8 is rotatably mounted to the at least one vehicle-storage unit 5. Accordingly, the at least one vehicle-storage unit 5 rests on the at least one idle axles 8 and can be rolled along a road or rail. An input 71 for each of the at least one secondary generators 7 is torsionally connected to a corresponding axle from the at least one idle axles 8. As a result, the at least one idle axles 8 function as the rotors for the at least one secondary generators 7. In this way, the at least one secondary generator 7 converts the kinetic motion of the at least one vehicle-storage unit 5 into electrical energy. Additionally, the at least one secondary generator 7 is electrically connected to the power management unit 14 so that the electrical power being generated can be transferred to the primary battery bank 2 or the secondary battery bank 6 through the power management unit 14. In the present invention, the at least one secondary generator 7 is preferably a regenerative break. The regenerative break is used to convert a portion of the kinetic energy of the vehicle into electrical energy. This conversion takes place while the vehicle is breaking.

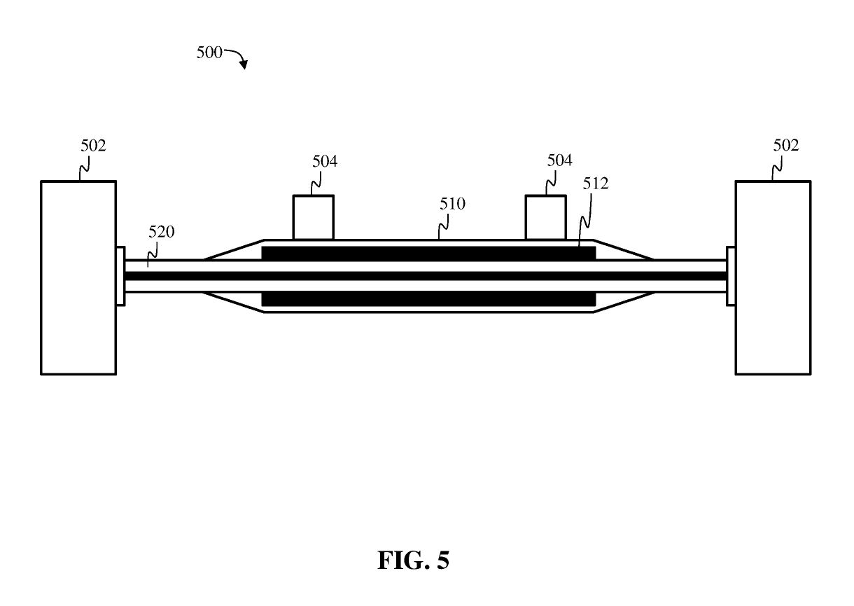

FIG. 5 is a cross sectional view of an axle and electrical generator 500, according to one embodiment of the present invention. FIG. 5 shows the axle and electrical generator 500 comprising a main axle assembly housing 510 statically coupled to a wheel 502 at each end. The wheel axle 520, which spins or rotates as the wheels rotate during movement of the vehicle, extends through the main axle assembly housing 510. The wheel axle 520 also acts as the rotor, which includes magnets or magnetic capabilities. A plurality of magnets may be coupled to the circumference of the wheel axle along a substantial portion of a length of the wheel axle. The main axle assembly housing 510 also includes a stator 512 which includes a field coil or field winding. As the wheel axle 520 rotates, an electric current is induced in the stator 512 via the field coil or field winding. The field winding may surround a substantial portion of a length of the wheel axle. The main axle assembly housing 510 also includes a pair of mounting points to which the vehicle or tractor trailer may be attached.

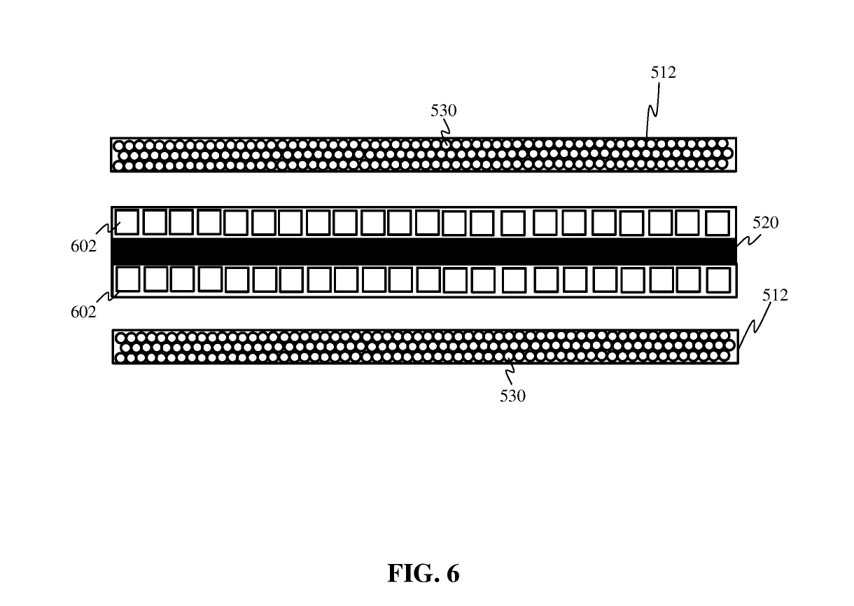

FIG. 6 is a close-up, cross sectional view of the axle and electrical generator 500 of FIG. 5, according to one embodiment of the present invention. FIG. 6 shows the wheel axle 520 spins or rotates as the wheels rotate during movement of the vehicle. The wheel axle 520 also acts as a rotor, due to a plurality of magnets 602 located around a circumference of the wheel axle 520. The main axle assembly housing 510 also includes a stator 512 which includes a field coil or field winding 530. As the wheel axle 520 rotates, an electric current is induced in the stator 512 via the field coil or field winding 530. In this way, the axle and electrical generator 500 generates electrical energy that may be provided to the electrical system of the vehicle or tractor trailer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A generator and electrical motor for a multi-axle vehicle comprises:
a main axle assembly housing;
a wheel axle that extends through the main axle assembly housing;
a wheel statically coupled to each end of the wheel axle;
a plurality of magnets coupled to a circumference of the wheel axle;
a stator within the main axle assembly housing, the stator including a field winding that surrounds the wheel axle, such that rotation of the wheel axle induces a current in the field winding; and
at least one vehicle mount on an exterior of the main axle assembly, the at least one vehicle mount configured for coupling to the vehicle.

2. The generator and electrical motor of claim 1 wherein the multi-axle vehicle is a tractor trailer.

3. The generator and electrical motor of claim 2 wherein the plurality of magnets are coupled to the circumference of the wheel axle along a substantial portion of a length of the wheel axle.

4. The generator and electrical motor of claim 3 wherein the field winding surrounds a substantial portion of a length of the wheel axle.

5. The generator and electrical motor of claim 4 wherein the at least one vehicle mount on the exterior of the main axle assembly comprises at least a pair of vehicle mounts on the exterior of the main axle assembly.

6. A system for providing generation of electrical energy in a multi-axle vehicle, comprising:
a) a generator and electrical motor comprising:
a main axle assembly housing;
a wheel axle that extends through the main axle assembly housing;
a wheel statically coupled to each end of the wheel axle;
a plurality of magnets coupled to a circumference of the wheel axle;
a stator within the main axle assembly housing, the stator including a field winding that surrounds the wheel axle, such that rotation of the wheel axle induces a current in the field winding; and
at least one vehicle mount on an exterior of the main axle assembly, the at least one vehicle mount configured for coupling to the vehicle; and
b) a battery bank conductively coupled with the main axle assembly such that electrical current produced by the main axle assembly charges batteries in the battery bank.

7. The system of claim 6 wherein the multi-axle vehicle is a tractor trailer.

8. The system of claim 7 wherein the plurality of magnets are coupled to the circumference of the wheel axle along a substantial portion of a length of the wheel axle.

9. The system of claim 8 wherein the field winding surrounds a substantial portion of a length of the wheel axle.

10. The system of claim 9 wherein the at least one vehicle mount on the exterior of the main axle assembly comprises at least a pair of vehicle mounts on the exterior of the main axle assembly.

11. A system for providing generation of electrical energy in a multi-axle vehicle, comprising:
a) a generator and electrical motor comprising:
a main axle assembly housing;
a wheel axle that extends through the main axle assembly housing;
a wheel statically coupled to each end of the wheel axle;
a plurality of magnets coupled to a circumference of the wheel axle;
a stator within the main axle assembly housing, the stator including a field winding that surrounds the wheel axle, such that rotation of the wheel axle induces a current in the field winding; and
at least one vehicle mount on an exterior of the main axle assembly, the at least one vehicle mount configured for coupling to the vehicle;
b) a battery bank conductively coupled with the main axle assembly such that electrical current produced by the main axle assembly charges batteries in the battery bank; and
c) at least one drive axle for the multi-axle vehicle, the at least one drive axle being operatively coupled to the generator and electrical motor, wherein the generator and electrical motor is used to rotate the at least one drive axle.

12. The system of claim 11 wherein the multi-axle vehicle is a tractor trailer.

13. The system of claim 12 wherein the plurality of magnets are coupled to the circumference of the wheel axle along a substantial portion of a length of the wheel axle.

14. The system of claim 13 wherein the field winding surrounds a substantial portion of a length of the wheel axle.

15. The system of claim 14 wherein the at least one vehicle mount on the exterior of the main axle assembly comprises at least a pair of vehicle mounts on the exterior of the main axle assembly.
